(19) United States
(12) Patent Application Publication
(10) Pub. No.: US 2026/0067863 A1
(43) Pub. Date: Mar. 5, 2026

(54) APPARATUS AND METHOD FOR PAGING ENHANCEMENT ASSOCIATED WITH NTN-TN INTERWORKING

(71) Applicant: InterDigital Patent Holdings, Inc., Wilmington, DE (US)

(72) Inventors: Brian Martin, Farnham (GB); Dylan Watts, Montreal (CA); Oumer Teyeb, Montreal (CA); Moon-il Lee, Melville, NY (US); Janet A. Stern-Berkowitz, Little Neck, NY (US)

(73) Assignee: InterDigital Patent Holdings, Inc., Wilmington, DE (US)

(21) Appl. No.: 19/101,066

(22) PCT Filed: Aug. 4, 2023
(86) PCT No.: PCT/US2023/029456

§ 371 Date: Feb. 4, 2025

Related U.S. Application Data
(60) Provisional application No. 63/395,746, filed on Aug. 5, 2022.

(51) Int. Cl. H04W 68/02; H04W 48/20

(52) U.S. Cl. CPC H04W 68/02; H04W 48/20

(57) ABSTRACT

Method and apparatus are described herein for paging and responding in different networks, i.e. a non-terrestrial network, NTN, to a terrestrial network, TN. A wireless transmit/receive unit, WTRU, e.g., camping in an idle or inactive state, monitors for paging on a NTN network. The WTRU receives a paging message on the NTN. The paging message provided an indication to respond on a TN network. The WTRU performs a cell reselection to the TN. The WTRU responds to the paging on the NTN network by sending a paging response message on the TN network.

### CROSS-REFERENCE TO RELATED APPLICATIONS

This application claims the benefit of U.S. Provisional Patent Application No. 63/395,746, filed Aug. 5, 2022, the contents of which are hereby incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for paging and responding in different networks, such as a non-terrestrial network (NTN) to a terrestrial network (TN), a TN to an NTN, an NTN to another NTN, etc. For example, a wireless transmit/receive unit (WTRU) (e.g., camping in an idle or inactive state) may monitor for paging on a first network (e.g., the NTN). The WTRU may receive a paging message on the NTN. The paging message may provide an indication to respond on a second network (e.g., the TN). The WTRU may perform a cell reselection to the TN. The WTRU may respond to the paging on the first network (e.g., the NTN) by sending a paging response message on the second network (e.g., the TN).

An example WTRU may receive, from an NTN node, a paging message. The paging message may indicate: for the WTRU to respond to the paging message on a TN, a first target TN cell, a second target TN cell, first priority information associated with the first target TN cell, second priority information associated with the second target TN cell, first timing information associated with the first target TN cell, and second timing information associated with the second target TN cell. The WTRU may select a TN cell, from the first target TN cell and the second target TN cell, based at least on the first priority information and the second priority information. The WTRU may apply timing information associated with the selected TN cell. The WTRU may send, to a TN node associated with the selected TN cell, an access request to initiate a connection on the selected TN cell. The access request may indicate that the access request was triggered by the NTN node.

Selecting the TN cell, from the first target TN cell and the second target TN cell, may be further based on satisfaction of a condition. The condition may be satisfied if the paging message is scrambled with a radio network temporary identifier (RNTI) associated with cell redirection. The paging message may include a service type indicator. Selecting the TN cell, from the first target TN cell and the second target TN cell, may be further based on the service type indicator.

The paging message may further indicate first uplink resources associated with the first target TN cell and second uplink resources associated with the second target TN cell. Sending the access request to the selected TN cell may involve sending the access request using uplink resources associated with the selected TN cell.

The first target TN cell may be associated with a first reference signal quality. The second target TN cell may be associated with a second reference signal quality. Selecting the TN cell, from the first target TN cell and the second target TN cell, may be further based on the first reference signal quality and the second reference signal quality.

The first target TN cell may be associated with a first frequency. The second target TN cell may be associated with a second frequency. Selecting the TN cell, from the first target TN cell and the second target TN cell, may be further based on a first difference between the first frequency and a target frequency, and a second difference between the second frequency and the target frequency.

The WTRU may send a measurement report to the NTN node. The measurement report may indicate a request for the first priority information associated with the first target TN cell and the second priority information associated with the second target TN cell. The first priority information and the second priority information may be based on the measurement report.

An example WTRU may identify one or more target TN cells. The WTRU may receive, from an NTN node, a paging message that indicates: a TN cell of the one or more target TN cells, for the WTRU to respond to the paging message on the TN cell, and timing information associated with the TN cell. The WTRU may apply the timing information associated with the TN cell. The WTRU may send, to a TN node associated with the TN cell, an access request to initiate a connection on the TN cell. The access request may indicate that the access request was triggered by the NTN node.

The WTRU may, upon sending the access request, start a timer. On a condition that the connection failed or no access response was received by expiration of the timer, the WTRU may send a response to the NTN node, or monitor for subsequent paging messages from the NTN node.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of multiple interfaces in a non-terrestrial network.

FIG. 3 illustrates an example of a WTRU-triggered transition from an idle state, such as an RRC_IDLE state, to a connected state, such as an RRC_CONNECTED state.

FIG. 4 illustrates an example of a rejection from the network of a WTRU triggered transition from an idle state, such as an RRC_IDLE state, where the WTRU may attempt to set up a connection from the idle state.

FIG. 5 illustrates an example of a WTRU triggered transition from an inactive state, such as an RRC_INACTIVE state, to a connected state, such as an RRC_CONNECTED state.

FIG. 6 illustrates an example of a WTRU triggered transition from an inactive state, such an RRC_INACTIVE state, to a connected state, such as an RRC_CONNECTED state.

FIG. 7 illustrates an example of a rejection from the network when the WTRU attempts to resume a connection from an inactive state, such as an RRC_INACTIVE state.

FIG. 8 illustrates an example of a network triggered transition from an inactive state, such as an RRC_INACTIVE state, to a connected state, such as an RRC_CONNECTED state.

FIG. 9 illustrates an example of a radio access network (RAN) based notification area (RNA) update procedure with WTRU context relocation.

FIG. 10 illustrates an example of a periodic RNA update procedure without WTRU context relocation.

FIG. 11 illustrates an example of an RNA update procedure with a transition to an idle state, such as an RRC_IDLE state.

FIG. 12 illustrates an example of a resume request that may include a response with a release with redirect and may include WTRU context relocation.

FIG. 13 illustrates an example of a procedure for core network (CN) controlled subgrouping.

FIG. 14 illustrates an example of a procedure for WTRU ID based subgrouping.

FIG. 15 illustrates an example of NTN-TN network layers.

FIG. 16 illustrates an example of paging a WTRU in an NTN with a paging response by the WTRU in a TN.

FIG. 17 illustrates an example procedure for paging a WTRU in an NTN cell with a response by the WTRU in a TN cell.

### EXAMPLE NETWORKS FOR IMPLEMENTATION OF THE EMBODIMENTS

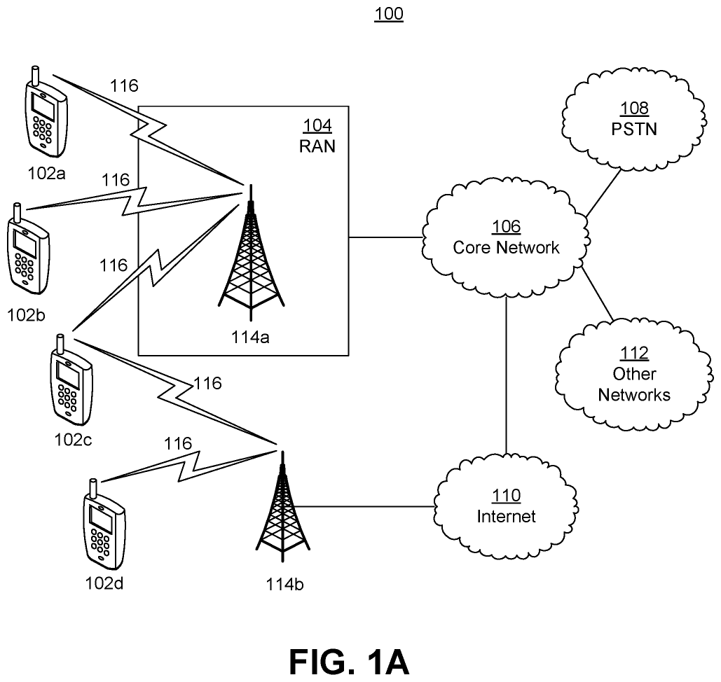

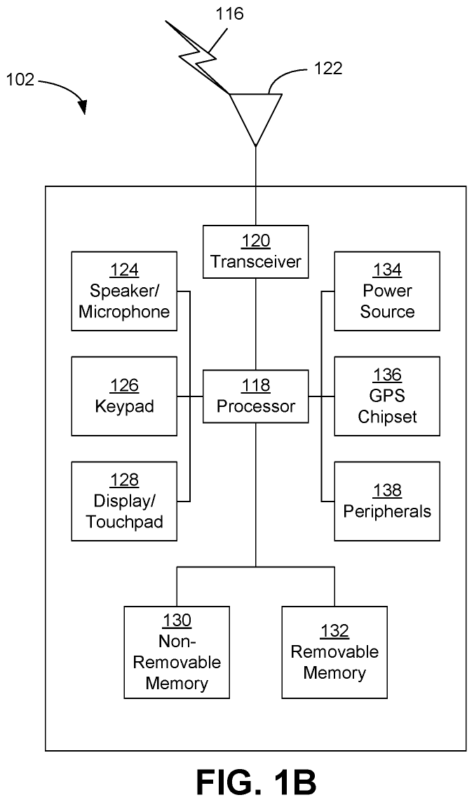

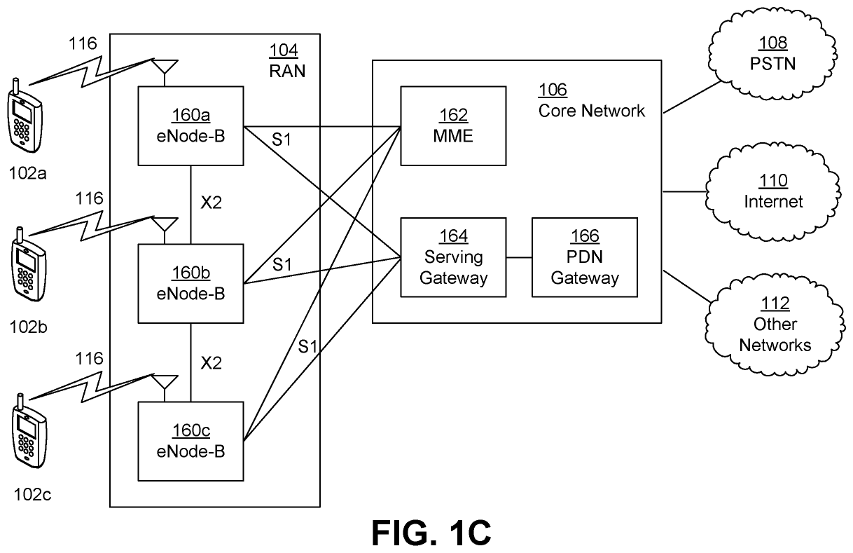

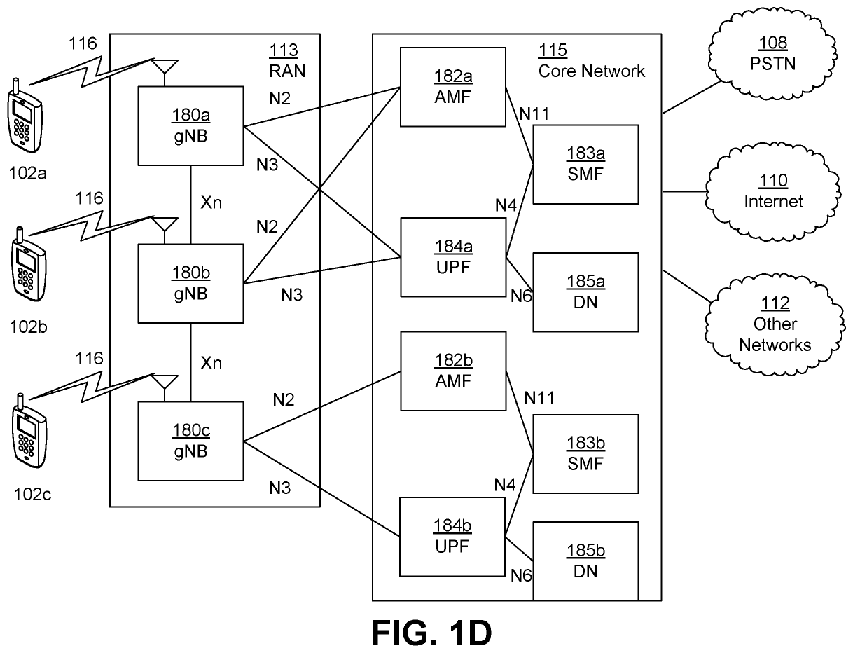

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Non-Terrestrial Networks (NTN) may facilitate deployment of wireless networks in areas where land-based antennas may be impractical, for example, due to geography or cost. NTNs coupled with TNs may enable ubiquitous network coverage (e.g., by 5G networks). NTN deployments may support basic talk and text anywhere in the world. NTN, TN, and low-orbit satellites may enable enhanced services (e.g., web browsing for NTNs).

An NTN may include an aerial or space-borne platform which may transport signals from a land-based based gNB to a WTRU and vice-versa (e.g., via a gateway (GW)). An NTN may support one or more WTRUs (e.g., power class 3 WTRUs). The WTRUs may have an omnidirectional antenna and/or linear polarization. The WTRUs may have a (e.g., very) small aperture antenna terminal (VSAT) with directive antenna and/or circular polarization. Support for LTE-based narrow-band IoT (NB-IoT) and enhanced Machine Type Communication (eMTC) type devices may be supported by NTNs. NTN WTRUs may be GNSS capable.

Aerial or space-borne platforms may be classified in terms of orbit (e.g., low-earth orbit (LEO) satellites with an altitude range of 300-1500 km, geostationary earth orbit (GEO) satellites with an altitude at 35,786 km, medium-earth orbit (MEO) satellites with altitude range 7000-25000 km and high-altitude platform stations (HAPS) with an altitude of 8-50 km). Satellite platforms may be (e.g., further) classified as having a transparent or regenerative payload. Transparent satellite payloads may implement frequency conversion and/or RF amplification in uplink and/or downlink. Multiple transparent satellites may be connected to a land-based gNB. Regenerative satellite payloads may implement a gNB (e.g., a full gNB) or gNB distributed unit (DU) onboard the satellite. Regenerative payloads may perform digital processing on signals (e.g., including demodulation, decoding, re-encoding, re-modulation, and/or filtering).

One or more of the following radio interfaces may be defined (e.g., configured) in NTN: feeder-link (e.g., a wireless link between the GW and satellite); service link (e.g., a radio link between the satellite and WTRU); and/or inter-satellite link (ISL) (e.g., a transport link between satellites). An ISL may be supported by (e.g., only by) regenerative payloads. An ISL may be, for example, a radio (e.g., 3GPP radio) or optical interface.

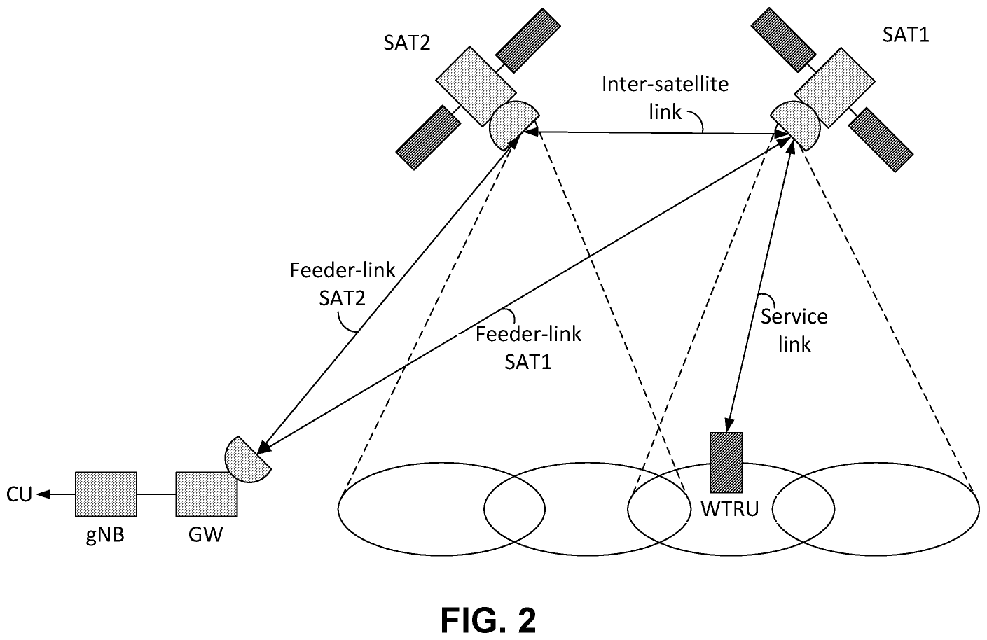

FIG. 2 illustrates an example of multiple interfaces in an NTN. An interface (e.g., different 3GPP interfaces) may be used for a (e.g., each) radio link (e.g., based on a satellite payload configuration). An NR-Uu radio interface may be used for a service link and/or a feeder-link (e.g., for a transparent payload). An NR-Uu interface may be used on the service link (e.g., for a regenerative payload). A satellite radio interface (SRI) may be used for the feeder-link (e.g., for a regenerative payload). A UP/CP protocol stack may be provided for a payload configuration (e.g., each payload configuration).

An NTN satellite may support multiple cells. A cell (e.g., each cell) may include one or more satellite beams. Satellite beams may cover a footprint on earth (e.g., like a terrestrial cell). Satellite beams may range in diameter from 100-1000 km in LEO deployments, and 200-3500 km diameter in GEO deployments. Beam footprints in GEO deployments may remain fixed relative to earth. The area covered by a beam/cell in LEO deployments may change over time (e.g., due to satellite movement). Beam movement may be classified as Earth-moving (e.g., if the LEO beam moves continuously across the Earth), or Earth-fixed (e.g., if the beam is steered to remain covering a fixed location until a new cell overtakes the coverage area.

A round-trip time (RTT) and/or a maximum differential delay may be larger for NTN platforms than for terrestrial systems (e.g., due to the altitude of NTN platforms and/or due to beam diameter). In an example of a transparent NTN deployment, RTT may range from 25.77 milliseconds (e.g., for LEO @ 600 km altitude) to 541.46 milliseconds (e.g., for GEO), with a maximum differential delay from 3.12 milliseconds to 10.3 milliseconds. The RTT of a regenerative payload may be approximately half that of a transparent payload. A transparent configuration may include service and feeder links. The RTT of a regenerative payload may include (e.g., only include) the service link. A WTRU may perform timing pre-compensation (e.g., prior to initial access). For example, the WTRU may perform timing pre-compensation to reduce/minimize an impact to existing network systems (e.g., to avoid preamble ambiguity or to properly time reception windows).

Pre-compensation may involve the WTRU obtaining its position (e.g., via GNSS), and/or the feeder-link (e.g., or common) delay and satellite position (e.g., via satellite ephemeris data). The satellite ephemeris data may be (e.g., periodically) broadcast in system information (SI). Satellite ephemeris data may include the satellite speed, direction, and/or velocity. The WTRU may estimate the distance (e.g., and thus delay) from the satellite. The WTRU may add the feeder-link delay component to obtain the full WTRU-gNB RTT (e.g., UE-gNB RTT). The WTRU-gNB RTT may be used to offset timers, reception windows, and/or timing relations. In some examples, frequency compensation may be performed by the network.

WTRU mobility and measurement reporting may be provided. The difference in RSRP between cell center and cell edge may not be as pronounced in NTN as in terrestrial systems. Measurement-based mobility may be less reliable in an NTN environment (e.g., based on a larger region of cell overlap). A network may utilize a conditional handover and/or measurement reporting triggers, which may rely on location and time. Enhanced mobility may be implemented, for example, in LEO deployments, where (e.g., due to satellite movement) a stationary WTRU may perform mobility (e.g., approximately every seven seconds), depending on deployment characteristics.

Mobility, state transition, and/or paging may be implemented for a WTRU in an idle state (e.g., RRC_IDLE), an inactive state (e.g., RRC-INACTIVE), and/or a connected state (e.g., RRC_CONNECTED). As used herein, the term idle state may be used interchangeably with RRC_IDLE state, the term inactive state may be used interchangeably with RRC_INACTIVE state, and the term connected state may be used interchangeably with RRC_CONNECTED state.

Mobility may be implemented in an idle state (e.g., RRC_IDLE). Cell selection may be implemented in an idle state (e.g., RRC_IDLE).

Public land mobile network (PLMN) selection in a network (e.g., NR) may be based on (e.g., 3GPP) PLMN selection principles. Cell selection may occur, for example, on transition from RM-DEREGISTERED to RM-REGISTERED, from CM-IDLE to CM-CONNECTED, and/or from CM-CONNECTED to CM-IDLE. Cell selection may be based on one or more of the following principles.

A WTRU non-access stratum (NAS) layer may identify a selected PLMN and/or equivalent PLMNs.

Cell selection may be based on cell defining (CD) synchronization signal blocks (CD-SSBs) located on the synchronization raster. The WTRU may search network (e.g., NR) frequency bands. The WTRU may identify a strong cell (e.g., the strongest cell) for a carrier frequency (e.g., for each carrier frequency) as per the CD-SSB. The WTRU may read cell system information broadcast to identify the PLMN(s). The WTRU may search a carrier (e.g., each carrier), for example, during initial cell selection, or may make use of stored information to shorten the search (e.g., stored information cell selection).

The WTRU may seek to identify a suitable cell. A WTRU may seek to identify an acceptable cell if the WTRU may not be able to identify a suitable cell. The WTRU may find a suitable cell or an acceptable cell. The WTRU may camp on the suitable cell or acceptable cell and commence the cell reselection procedure. A suitable cell may be a cell for which the measured cell attributes satisfy the cell selection criteria. The cell PLMN may be the selected PLMN (e.g., a registered PLMN or an equivalent PLMN). The cell may not be barred or reserved. The cell may not be part of a tracking area in a list of forbidden tracking areas for roaming. An acceptable cell may be a cell that is not barred and that has measured cell attributes that satisfy the cell selection criteria.

The IAB-MT may apply the cell selection as described for the WTRU. The IAB-MT may ignore cell-barring or cell-reservation indications included in a cell system information broadcast. The IAB-MT may consider (e.g., only consider) a cell as a candidate for cell selection if the cell system information broadcast indicates IAB support for the selected PLMN or the selected SNPN.

A WTRU may transition to an idle state (e.g., RRC_IDLE). On transition from a connected or inactive state (e.g., RRC_CONNECTED or RRC_INACTIVE) to an idle state (e.g., RRC_IDLE), a WTRU may camp on a cell as result of cell selection (e.g., according to the frequency assigned by RRC in a state transition message, if any).

In multi-beam operations, the cell quality may be derived amongst the beams corresponding to the same cell.

Cell reselection may be implemented. A WTRU in an idle state (e.g., RRC_IDLE) may perform cell reselection. Cell reselection may be implemented based on one or more of the following. Cell reselection may be based on CD-SSBs located on the synchronization raster. A WTRU may take measurements of attributes of the serving and neighbor cells to enable the reselection process. The carrier frequencies (e.g., only the carrier frequencies) may be indicated for the search and measurement of inter-frequency neighboring cells. Cell reselection may identify the cell that the WTRU should camp on. Cell reselection may be based on cell reselection criteria, which may involve measurements of the serving and neighbor cells. Intra-frequency reselection may be based on ranking of cells. Inter-frequency reselection may be based on absolute priorities (e.g., where a WTRU may try to camp on an available high frequency priority, for example, the highest priority frequency available). A neighbor cell list (NCL) may be provided by the serving cell to handle specific cases for intra- and inter-frequency neighboring cells. Exclude-lists may be provided to prevent the WTRU from reselecting to specific intra- and inter-frequency neighboring cells. Allow-lists may be provided to request the WTRU to reselect to specific (e.g., only specific) intra- and inter-frequency neighboring cells. Cell reselection may be speed dependent. Prioritization may be service-specific. Slice-specific cell reselection information may be provided to facilitate the WTRU to reselect a cell that supports specific slices. In multi-beam operations, the cell quality may be derived based on the beams corresponding to the same cell.

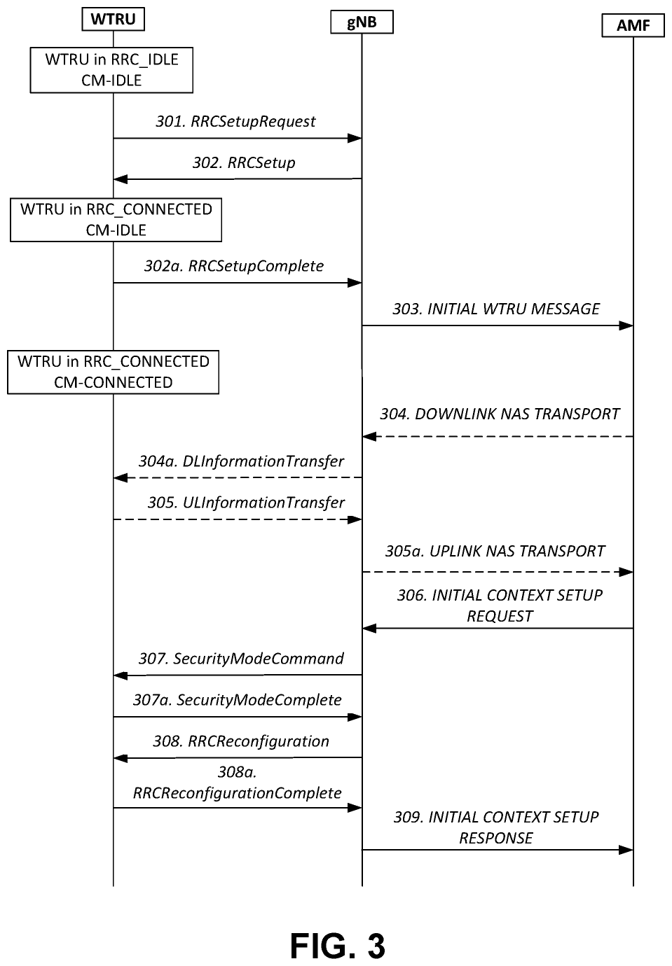

State transitions may be performed and/or provided. FIG. 3 illustrates an example of a WTRU-triggered transition from an idle state to a connected state (e.g., RRC_IDLE state to RRC_CONNECTED state). As shown in FIG. 3, at 301, the WTRU may request to setup a connection from an idle state (e.g., RRC_IDLE). At 302/302a, the gNB may complete the RRC setup procedure. A scenario where the gNB rejects the request is described below. At 303, a first NAS message from the WTRU may be sent to the AMF (e.g., piggybacked in RRCSetupComplete). At 304/304a/305/305a, additional NAS messages may be exchanged between the WTRU and the AMF. At 306, the AMF may prepare the WTRU context data (e.g., including PDU session context, the security key, WTRU radio capabilities, WTRU security capabilities, etc.). The AMF may send the context data to the gNB. At 307/307a, the gNB may activate the AS security with the WTRU. At 308/308a, the gNB may perform the reconfiguration to setup SRB2 and DRBs for WTRU, or SRB2 and (e.g., optionally) DRBs for IAB-MT. At 309, the gNB may inform the AMF that the setup procedure is complete. The RRC messages at 301 and 302 may use SRB0. The subsequent messages may use SRB1. Messages at 307 and/or 307a may be integrity protected. At 308, 308a, and/or 309, the messages may be integrity protected and ciphered. A signaling (e.g., signaling-only) connection may skip 308 (e.g., because SRB2 and DRBs may not be set up.

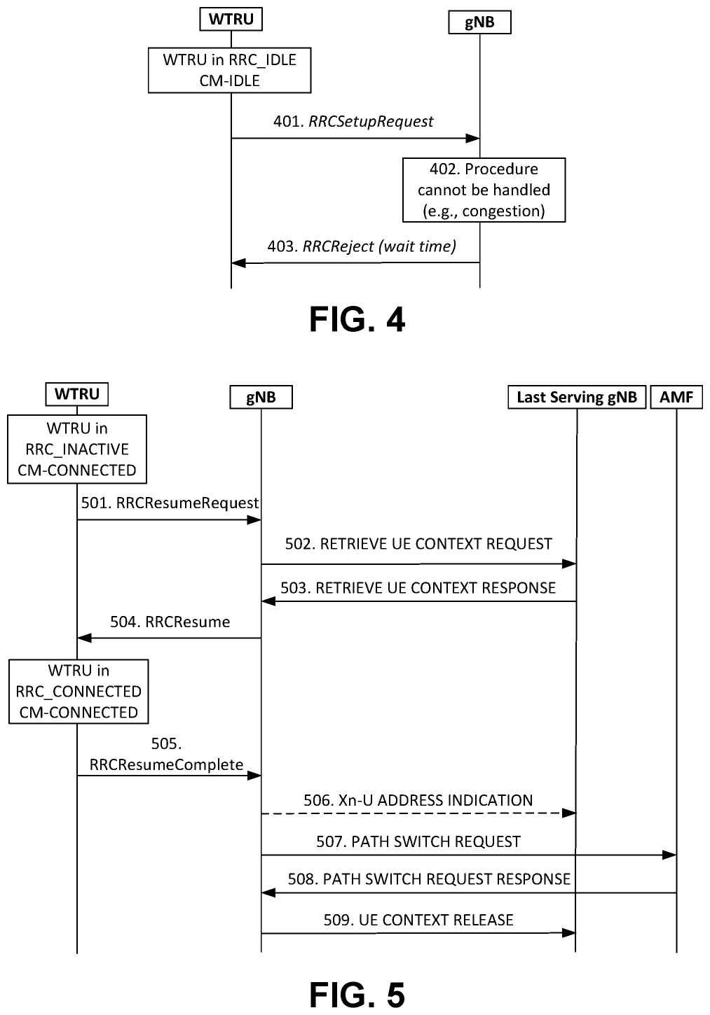

FIG. 4 illustrates an example a network rejecting a WTRU-triggered request to transition from an idle state (e.g., RRC_IDLE), where the WTRU may attempt to setup and/or establish a connection from an idle state (e.g., RRC_IDLE). As shown in FIG. 4, at 401, the WTRU may attempt to setup and/or establish a connection from an idle state (e.g., RRC_IDLE). At 402, the gNB may be unable to handle the procedure (e.g., due to congestion). At 403, the gNB may send a rejection message, such as RRCReject to keep the WTRU in an idle state (e.g., RRC_IDLE). The rejection message may include a wait time.

Mobility may occur in an inactive state (e.g., RRC_INACTIVE state). The inactive state (e.g., RRC_INACTIVE) may be a state in which a WTRU remains in CM-CONNECTED and may move within an area configured by NG-RAN (e.g., the RAN-based Notification Area (RNA) without notifying NG-RAN. In an inactive state (e.g., RRC_INACTIVE), the last serving gNB node may maintain/keep the WTRU context and the WTRU-associated NG connection with the serving AMF and UPF.

The last serving gNB may receive DL data from the UPF or DL WTRU-associated signaling from the AMF (e.g., except the UE Context Release Command message) while the WTRU is in an inactive mode (e.g., RRC_INACTIVE). The last serving gNB may page the cells corresponding to the RNA. The last serving gNB may send XnAP RAN paging to neighbor gNB(s) (e.g., if the RNA includes cells of neighbor gNB(s)).

The last serving gNB may receive the WTRU Context Release Command message (e.g., UE Context Release Command message) while the WTRU is in an inactive mode (e.g., RRC_INACTIVE). The last serving gNB may page in the cells corresponding to the RNA. The last serving gNB may send XnAP RAN paging to neighbor gNB(s) (e.g., if the RNA includes cells of neighbor gNB(s)), for example, to indicate (e.g., explicitly indicate) for the neighbor gNB(s) to release the WTRU.

The last serving gNB may receive the NG RESET message while the WTRU is in an inactive mode (e.g., RRC_INACTIVE). The last serving gNB may page involved WTRUs in the cells corresponding to the RNA. The last serving gNB may send XnAP RAN paging to neighbor gNB(s) (e.g., if the RNA includes cells of neighbor gNB(s), for example, to indicate (e.g., explicitly indicate) for the neighbor gNB(s) to release involved WTRUs.

The AMF may provide Core Network Assistance Information to the NG-RAN node (e.g., to assist the NG-RAN node decide whether the WTRU may be sent to an inactive state (e.g., RRC_INACTIVE), and/or to assist WTRU configuration and paging in an inactive state (e.g., RRC_INACTIVE). The Core Network Assistance Information may include one or more of the following: the registration area configured for the WTRU, a periodic registration update timer, the WTRU identity index value, the WTRU-specific discontinuous reception (DRX), an indication of whether the WTRU is configured with Mobile Initiated Connection Only (MICO) mode by the AMF, the expected WTRU behavior, the WTRU radio capability for paging, PEI with paging subgrouping assistance information, NR paging extended DRX (eDRX) information, and/or a paging cause indication for voice service.

The WTRU registration area may be used by the NG-RAN node when configuring the RNA. The WTRU-specific DRX and WTRU identity index value may be used by the NG-RAN node for RAN paging. The periodic registration update timer may be used by the NG-RAN node to configure a periodic RNA update timer. The NG-RAN node may use the expected WTRU behavior to assist the WTRU RRC state transition decision. The NG-RAN node may use the WTRU radio capability for paging during RAN paging. The NG-RAN node may use the PEI with paging subgrouping assistance information for subgroup paging in an inactive state (e.g., RRC_INACTIVE). The PEI with paging subgrouping assistance information may be included (e.g., if the XnAP RAN paging is sent to neighbor NG-RAN node(s)). The NG-RAN node may use the NR paging eDRX information to configure the RAN paging (e.g., if the NR WTRU is in an inactive state (e.g., RRC_INACTIVE). The NR paging eDRX information for an idle state (e.g., RRC_IDLE) and for an inactive state (e.g., RRC_INACTIVE) may be included (e.g., if XnAP RAN paging is sent to neighbor NG-RAN node(s)). The NG-RAN node may use the paging cause indication for voice service to determine whether to include the paging cause in RAN paging for a WTRU in an inactive state (e.g., RRC_INACTIVE state). The paging cause may be included, for example, if XnAP RAN paging is sent to neighbor NG-RAN node(s).

If a WTRU transitions to an inactive state (e.g., RRC_INACTIVE), the NG-RAN node may configure the WTRU with a periodic RNA update timer value. The periodic RNA update timer may expire without notification from the WTRU.

The WTRU may access a gNB other than the last serving gNB. The receiving gNB may trigger the XnAP to retrieve WTRU context procedure (e.g., UE context procedure) to get the WTRU context from the last serving gNB. The receiving gNB may trigger an Xn-U address indication (e.g., including tunnel information for potential recovery of data from the last serving gNB). The gNB may (e.g., upon successful WTRU context retrieval) perform the slice-aware admission control (e.g., in case of receiving slice information). The receiving gNB may become the serving gNB. The serving gNB may trigger the NGAP path switch request and applicable RRC procedures. The serving gNB (e.g., after the path switch) may trigger release of the WTRU context at the last serving gNB (e.g., using the XnAP UE Context Release procedure).

The WTRU may not be reachable at the last serving gNB. The gNB may fail an AMF-initiated WTRU-associated class 1 procedure that allows the signaling of unsuccessful operation in the respective response message. The gNB may trigger an NAS non-delivery indication to report the non-delivery of any non-PDU session related NAS PDU received from the AMF.

A WTRU may access a gNB other than the last serving gNB. The receiving gNB may not find a valid WTRU context. The receiving gNB may perform establishment of a new RRC connection (e.g., instead of resumption of the previous RRC connection). WTRU context retrieval may fail, which may lead to establishing a new RRC connection (e.g., if the serving AMF changes).

A WTRU in the inactive state (e.g., RRC_INACTIVE state) may initiate an RNA update procedure (e.g., if the WTRU moves out of the configured RNA). A receiving gNB may trigger the XnAP retrieve WTRU context procedure to get the WTRU context from the last serving gNB (e.g., if the gNB receives an RNA update request from the WTRU). The receiving gNB may decide to send the WTRU back to an inactive state (e.g., RRC_INACTIVE state), move the WTRU to a connected state (e.g., RRC_CONNECTED state), or send the WTRU to an idle state (e.g., RRC_IDLE). In an example of a periodic RNA update, the last serving gNB may decide not to relocate the WTRU context. The last serving gNB may fail the retrieve WTRU context procedure and may send the WTRU back to an inactive or idle state (e.g., RRC_INACTIVE, or to RRC_IDLE), for example, using a release message (e.g., directly by an encapsulated RRCRelease message).

A WTRU in an inactive state (e.g., RRC_INACTIVE) may perform cell reselection. A WTRU in the inactive state (e.g., RRC_INACTIVE state) may be configured by the last serving NG-RAN node with an RNA. The RNA may cover a single or multiple cells. The RNA may be included within the CN registration area. Xn connectivity may be available within the RNA. A RAN-based notification area update (RNAU) may be sent (e.g., periodically sent) by the WTRU. An RNAU may be sent if the cell reselection for the WTRU selects a cell that does not belong to the configured RNA.

An RNA may be configured (e.g., based on a list of cells and/or a list of RAN areas). An RNA may be configured based on a list of cells. For example, a WTRU may have an explicit list of one or more cells that make up the RNA. An RNA may be configured based on a list of RAN areas. For example, a WTRU may be provided with the least one RAN area ID. A RAN area may be a subset of a CN tracking area or the same as a CN tracking area. A RAN area may be specified by a RAN area ID (e.g., which may include a TAC and/or a RAN area code). A cell may broadcast one or more RAN area IDs in the system information.

An NG-RAN may provide different RNA definitions to different WTRUs (e.g., but may not mix different definitions to the same WTRU at the same time). A WTRU may support one or more RNA configuration options.

A WTRU may engage in state transitions. A state transition may be a WTRU-triggered transition from an inactive state to a connected state (e.g., RRC_INACTIVE to RRC_CONNECTED).

FIG. 5 illustrates an example of a WTRU-triggered transition from an inactive state to a connected state (e.g., RRC_INACTIVE to RRC_CONNECTED). For example, FIG. 5 illustrates an example of a WTRU-triggered transition from RRC_INACTIVE to RRC_CONNECTED with a successful WTRU context retrieval. As shown in FIG. 5, at 501, the WTRU may resume from an inactive state (e.g., RRC_INACTIVE). The WTRU may provide the I-RNTI, which may be allocated by the last serving gNB. At 502, the gNB may (e.g., if able to resolve the gNB identity included in the I-RNTI) request that the last serving gNB provide WTRU context data (e.g., UE context data). At 503, the last serving gNB may provide the WTRU context data (e.g., UE context data). At 504 and 505, the gNB and WTRU may complete the resumption of the connection (e.g., RRC connection). User data may be sent (e.g., at 505), for example, if the grant allows. At 506, the gNB may provide forwarding addresses (e.g., to prevent loss of DL user data buffered in the last serving gNB). At 507 and 508, the gNB may perform a path switch. At 509, the gNB may trigger the release of the WTRU resources (e.g., UE context release) at the last serving gNB.

SRB0 (e.g., without security) may not be used after 501. For example, SRB0 may not be used if the gNB decides to use a message (e.g., a single RRC message) to reject the resume request and keep the WTRU in an inactive state (e.g., RRC_INACTIVE) without any reconfiguration. SRB0 may not be used if the gNB decides to setup a connection (e.g., an RRC connection). SRB1 (e.g., with integrity protection and ciphering as previously configured for that SRB) may be used. For example, SRB1 may be used if the gNB decides to reconfigure the WTRU (e.g., with a new DRX cycle or RNA). SRB1 may be used if the gNB decides to send the WTRU to an idle state (e.g., RRC_IDLE).

SRB1 may (e.g., only) be used if the WTRU context is retrieved (e.g., after 503).

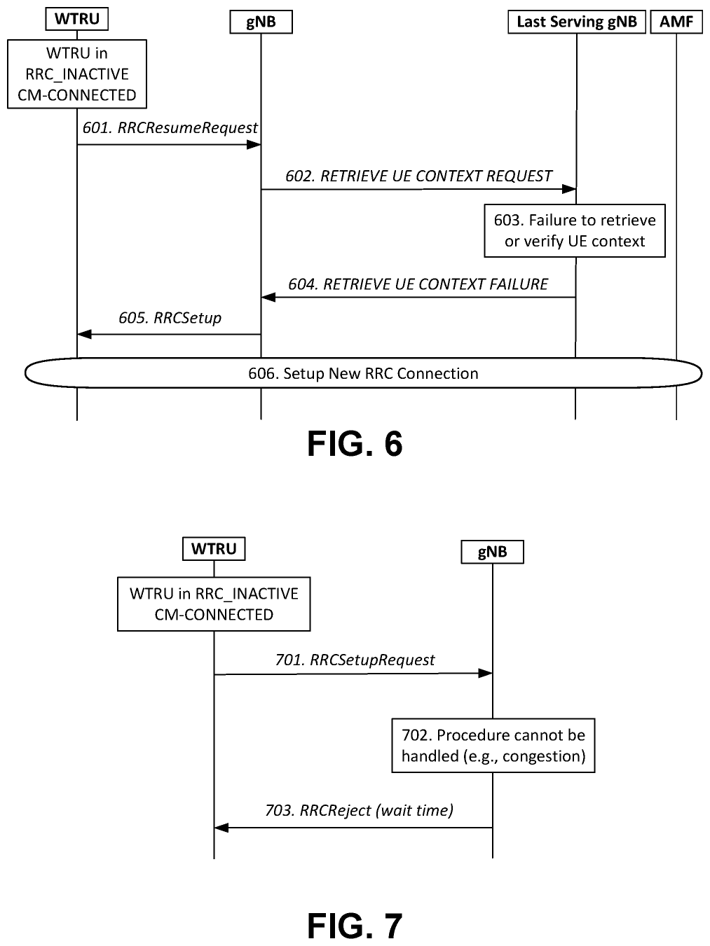

FIG. 6 illustrates an example of a WTRU-triggered transition from an inactive state to a connected state (e.g., RRC_INACTIVE to RRC_CONNECTED). For example, FIG. 6 illustrates an example of a WTRU-triggered transition from RRC_INACTIVE to RRC_CONNECTED with a WTRU context retrieval failure. As shown in FIG. 6, at 601, the WTRU may resume from an inactive state (e.g., RRC_INACTIVE). The WTRU may provide the I-RNTI, which may have been allocated by the last serving gNB. At 602, the gNB (e.g., if able to resolve the gNB identity included in the I-RNTI) may request that the last serving gNB provide WTRU context data (e.g., using a RETRIEVE UE CONTEXT FAILURE). At 603, the last serving gNB may not retrieve or verify the WTRU context data (e.g., using a RETRIEVE UE CONTEXT REQUEST). At 604, the last serving gNB may indicate the failure to the gNB. At 605, the gNB may perform a fallback to establish a connection (e.g., an RRC connection), for example, by sending a message (e.g., RRCSetup). At 606, a connection may be set up.

FIG. 7 illustrates an example of a rejection from the network when the WTRU attempts to resume a connection from an inactive state (e.g., RRC_INACTIVE). At shown in FIG. 7, at 701, The WTRU may attempt to resume the connection from an inactive state (e.g., RRC_INACTIVE). At 702, the gNB may be unable to handle the procedure (e.g., due to congestion). At 703, the gNB may send RRCReject (e.g., with a wait time) to keep the WTRU in the inactive state (e.g., RRC_INACTIVE).

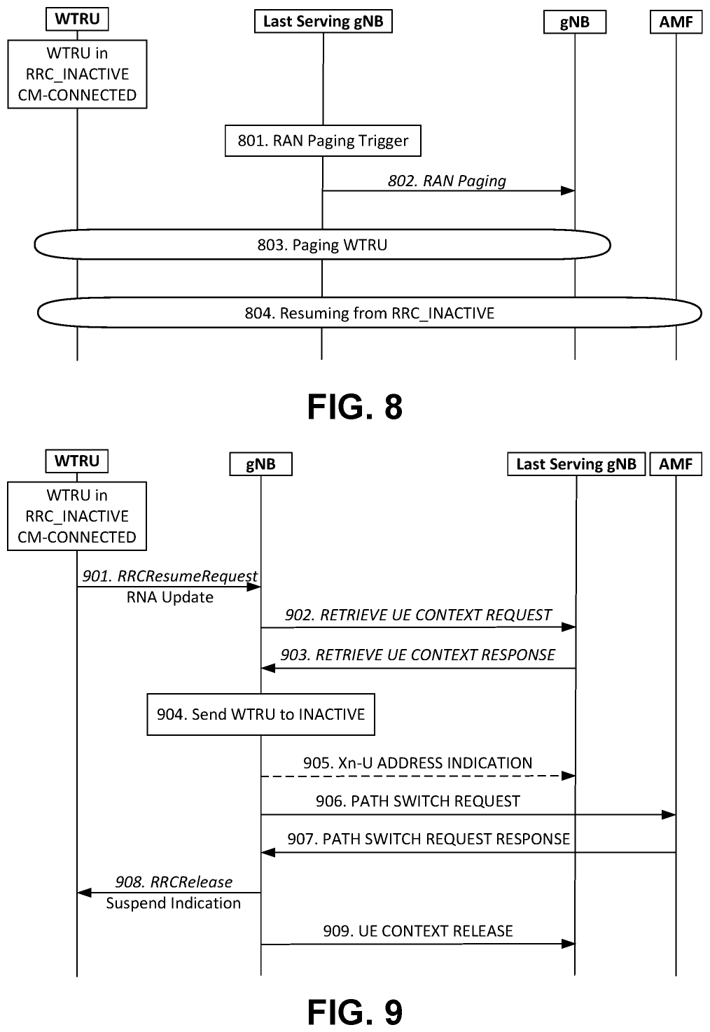

A transition from an inactive state to a connected state (e.g., RRC_INACTIVE to RRC_CONNECTED) may be network-triggered. FIG. 8 illustrates an example of a network-triggered transition from an inactive state to a connected state (e.g., RRC_INACTIVE to RRC_CONNECTED). As shown in FIG. 8, at 801, a RAN paging trigger event may occur (e.g., incoming DL user plane, DL signaling from 5GC, etc.). At 802, RAN paging may be triggered (e.g., in the cells controlled by the last serving gNB or by Xn RAN paging in cells controlled by other gNBs). The RAN paging may be configured to the WTRU in the RNA. At 803, the WTRU may be paged with the I-RNTI. At 804, the WTRU may be successfully reached. The WTRU may attempt to resume from an inactive state (e.g., RRC_INACTIVE).

An RNA update may be performed. An RNA update may be a WTRU-triggered RNA update procedure (e.g., involving context retrieval over Xn). The RNA update may be triggered by the WTRU moving out of the configured RNA. The RNA update may be triggered periodically.

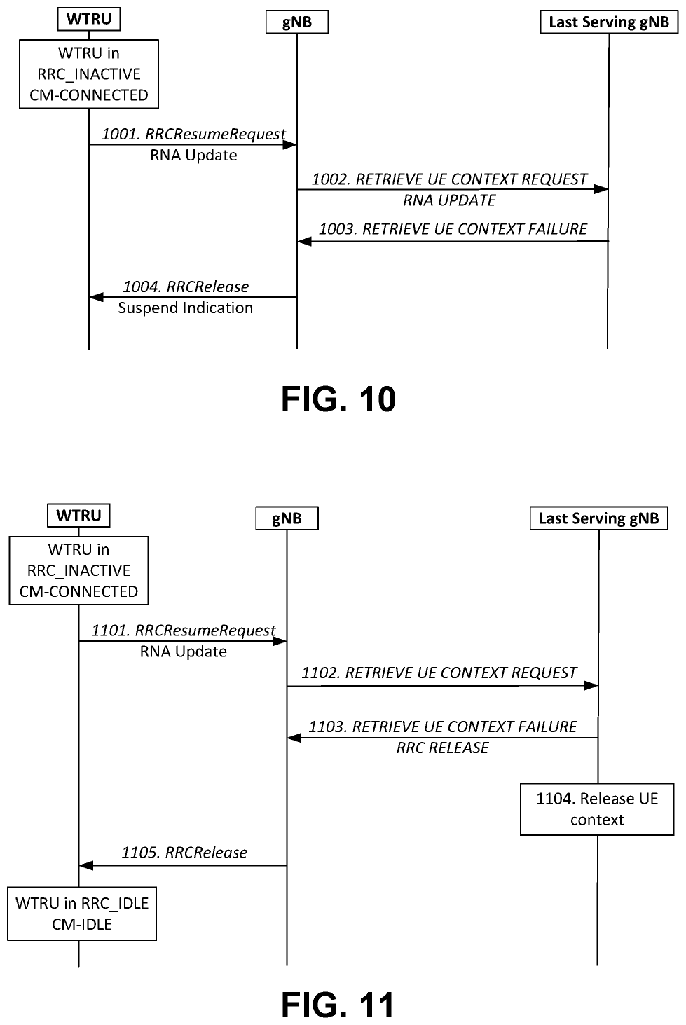

FIG. 9 illustrates an example of an RNA update procedure (e.g., with WTRU context relocation). As shown in FIG. 9, at 901, the WTRU may resume from an inactive state (e.g., RRC_INACTIVE). The WTRU may provide the I-RNTI, which may be allocated by the last serving gNB. The WTRU may provide an appropriate cause value (e.g., RAN notification area update). At 902, the gNB (e.g., if able to resolve the gNB identity included in the I-RNTI) may request that the last serving gNB provide WTRU context (e.g., using a RETRIEVE UE CONTEXT REQUEST, for example, providing the cause value received at 901). At 903, the last serving gNB may provide the WTRU context (e.g., using a RETRIEVE UE CONTEXT RESPONSE). The last serving gNB may decide to move the WTRU to an idle state (e.g., RRC_IDLE), as described with respect to FIG. 11, at 1103-1105. As illustrated in FIG. 9, the WTRU may be within the previously configured RNA. The WTRU context in the last serving gNB may be kept. The WTRU may be kept in an inactive state (e.g., RRC_INACTIVE), as described with respect to FIG. 10, at 1003-1004. At 904, the gNB may move the WTRU to a connected state (e.g., RRC_CONNECTED), as described with respect to FIG. 8, at 804. As illustrated in FIG. 9, the gNB may send the WTRU back to RRC_IDLE (e.g., in which case an RRCRelease message may be sent by the gNB). The gNB may send the WTRU back to an inactive state (e.g., RRC_INACTIVE). At 905, the gNB may provide forwarding addresses (e.g., to prevent the loss of DL user data buffered in the last serving gNB). At 906 and 907, the gNB may perform a path switch. At 908, the gNB may keep the WTRU in an inactive state (e.g., RRC_INACTIVE state). For example, the gNB may keep the WTRU in an inactive state by sending a message (e.g., RRCRelease) with a suspend indication. At 909, the gNB may trigger the release of the WTRU resources at the last serving gNB (e.g., using a UE CONTEXT RELEASE).

An RNA update may be implemented. For example, an RNA update may occur if the WTRU is within the configured RNA and the last serving gNB decides not to relocate the WTRU context and to keep the WTRU in an inactive state (e.g., RRC_INACTIVE).

FIG. 10 illustrates an example of a periodic RNA update procedure without WTRU context relocation. As shown in FIG. 10, at 1001, the WTRU may resume from an inactive state (e.g., RRC_INACTIVE). The WTRU may provide the I-RNTI, which may be allocated by the last serving gNB. The WTRU may provide an appropriate cause value (e.g., RAN notification area update). At 1002, the gNB (e.g., if able to resolve the gNB identity included in the I-RNTI) may request that the last serving gNB provide WTRU context (e.g., using a RETRIEVE UE CONTEXT REQUEST, for example, providing the cause value received at 1001). At 1003, the last serving gNB may store received information to be used in the next resume attempt (e.g., C-RNTI and PCI related to the resumption cell). The last serving gNB may respond to the gNB with a RETRIEVE WTRU CONTEXT FAILURE message (e.g., a RETRIEVE UE CONTEXT FAILURE message, for example, including an encapsulated RRCRelease message). The RRCRelease message may include a suspend indication. At 1004, the gNB may forward the RRCRelease message to the WTRU.

An RNA update may be implemented if the last serving gNB decides to move the WTRU to an idle state (e.g., RRC_IDLE).

FIG. 11 illustrates an example of an RNA update with a transition to an idle state (e.g., RRC_IDLE). As shown in FIG. 11, at 1101, the WTRU may resume from an inactive state (e.g., RRC_INACTIVE). The WTRU may provide the I-RNTI, which may be allocated by the last serving gNB. The WTRU may provide an appropriate cause value (e.g., RAN notification area update). At 1102, the gNB (e.g., if able to resolve the gNB identity included in the I-RNTI) may request that the last serving gNB provide WTRU context (e.g., using a RETRIEVE UE CONTEXT REQUEST, for example, providing the cause value received at 1101). At 1103, the last serving gNB may provide an RRCRelease message (e.g., instead of providing the WTRU context, for example, in addition to a RETRIEVE UE CONTEXT FAILURE) to move the WTRU to an idle state (e.g., RRC_IDLE). At 1104, the last serving gNB may delete the WTRU context (e.g., UE context). At 1105, the gNB may send the RRCRelease, which may trigger the WTRU to move to an idle state (e.g., RRC_IDLE).

A resume request response may include a release with redirect indication and/or WTRU context relocation. The network may respond to a WTRU-triggered resume request (e.g., an NAS procedure). For example, the network may respond with a release with redirect (e.g., with WTRU context relocation).

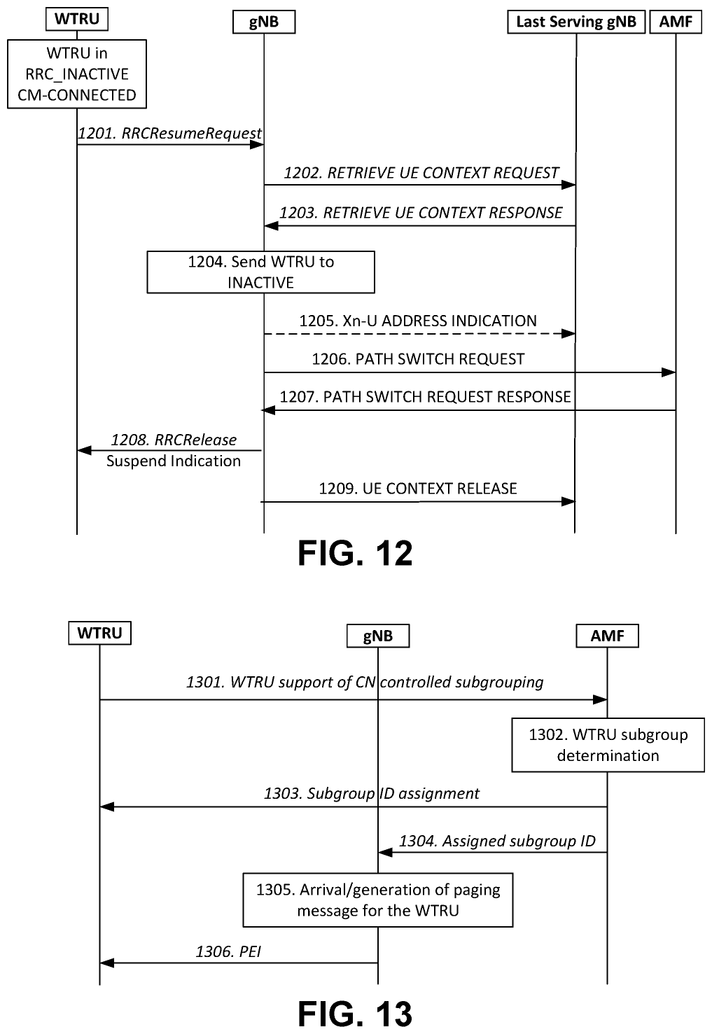

FIG. 12 illustrates an example of a resume request, and a response with a release with redirect and WTRU context relocation. As shown in FIG. 12, at 1201, the WTRU may resume from an inactive state (e.g., RRC_INACTIVE). The WTRU may provide the I-RNTI, which may be allocated by the last serving gNB. At 1202, the gNB (e.g., if able to resolve the gNB identity included in the I-RNTI) may request that the last serving gNB provide WTRU context data (e.g., using a RETRIEVE UE CONTEXT REQUEST). At 1203, the last serving gNB may provide the WTRU context (e.g., using a RETRIEVE UE CONTEXT RESPONSE). At 1204, the gNB may move the WTRU to a connected state (e.g., RRC_CONNECTED), as described with respect to FIG. 8, at 804. Referring again to FIG. 12, the gNB may send the WTRU to an idle state (e.g., RRC_IDLE), in which case a message (e.g., an RRCRelease message) may be sent by the gNB. The gNB may send the WTRU to an inactive state (e.g., RRC_INACTIVE), for example, including a release with a redirect indication. At 1205, the gNB may provide forwarding addresses (e.g., to prevent the loss of DL user data buffered in the last serving gNB). At 1206-1207, the gNB may perform a path switch. At 1208, the gNB may keep the WTRU in an inactive state (e.g., RRC_INACTIVE), for example, by sending an RRCRelease with suspend indication (e.g., including redirection information). The redirection information may include a frequency layer in which the WTRU may perform cell selection based on entering inactive stateRRC_. At 1209, the gNB may trigger the release of the WTRU resources (e.g., using a UE CONTEXT RELEASE) at the last serving gNB. The higher layers may trigger a pending procedure, for example, based on receiving the release with redirect. The WTRU may try to resume again after cell selection.

Paging may allow the network to reach WTRUs in an idle state and inactive state (e.g., RRC_IDLE and in RRC_INACTIVE state) through paging messages. Paging may allow the network to notify WTRUs in idle, inactive, and/or connected states (e.g., RRC_IDLE, RRC_INACTIVE and RRC_CONNECTED states) about system information changes and/or ETWS/CMAS indications through short messages. Paging messages and short messages may be addressed with P-RNTI on a physical downlink control channel (PDCCH). Paging messages may be sent on a paging control channel (PCCH). Short messages may be sent over PDCCH (e.g., directly).

A WTRU may (e.g., while in RRC_IDLE) monitor the paging channels for CN-initiated paging (e.g., while the WTRU is in an idle state). A WTRU may (e.g., while in RRC_INACTIVE without an ongoing SDT procedure) monitor paging channels for RAN-initiated paging and CN-initiated paging (e.g., while the WTRU is in an inactive state without an ongoing SDT procedure). A WTRU may not continuously monitor paging channels. Paging DRX may support discrete or periodic monitoring. A WTRU in an idle state or an inactive state (e.g., RRC_IDLE or RRC_INACTIVE) may monitor paging channels during a paging occasion (PO) in a DRX cycle. For example, paging DRX cycles may be configured by the network for CN-initiated paging (e.g., a default cycle may be broadcast in system information). Paging DRX cycles may be configured by the network for CN-initiated paging (e.g., a WTRU-specific cycle may be configured via NAS signaling). Paging DRX cycles may be configured by the network for RAN-initiated paging (e.g., a WTRU-specific cycle may be configured via RRC signaling). A WTRU may use the shortest of the DRX cycles applicable. For example, a WTRU in an idle state (e.g., RRC_IDLE) may use the shorter of the first two DRX cycles. A WTRU in an inactive state (e.g., RRC_INACTIVE) may use the shortest of the first three DRX cycles.

The POs of a WTRU for CN-initiated and RAN-initiated paging may be based on the same WTRU ID, which may result in overlapping POs for both. The number of different POs in a DRX cycle may be configurable (e.g., via system information). A network may distribute WTRUs to the POs based on their IDs.

A WTRU (e.g., while in a connected state, such as RRC_CONNECTED, and/or while in an inactive state, such as RRC_INACTIVE with an ongoing SDT procedure) may monitor the paging channels in any PO signaled in system information for an SI change indication and/or a PWS notification. A WTRU (e.g., a WTRU in a connected state, such as RRC_CONNECTED) may (e.g., in case of BA) monitor (e.g., only monitor) paging channels on the active BWP with a common search space configured.

A WTRU (e.g., for operation with shared spectrum channel access) may be configured with a number of PDCCH monitoring occasions in the WTRU's PO to monitor for paging. The WTRU may detect a PDCCH transmission within the WTRU's PO addressed with P-RNTI. The WTRU may not monitor the subsequent PDCCH monitoring occasions within the PO.

A WTRU (e.g., a WTRU in an idle or inactive state, such as RRC_IDLE or RRC_INACTIVE) may use the paging cause (e.g., if the paging cause is included in the paging message).

Paging optimization may be performed for WTRUs (e.g., WTRUs in CM_IDLE). An NG-RAN node may (e.g., at WTRU context release) provide the AMF with a list of recommended cells and NG-RAN nodes as assistance information for subsequent paging. The AMF may provide paging attempt information. The paging attempt information may include a paging attempt count, the intended number of paging attempts, and/or the next paging area scope. Each paged NG-RAN node may receive the same information during a paging attempt (e.g., if the paging attempt information is included in the paging message). A paging attempt count may be increased (e.g., incremented by one) at each new paging attempt. The next paging area scope (e.g., if present) may indicate whether the AMF plans to modify the paging area currently selected at the next paging attempt. The paging attempt count may be reset (e.g., if the WTRU changed its state to CM_CONNECTED).

Paging optimization may be performed for WTRUs in an inactive state (e.g., RRC_INACTIVE). A serving NG-RAN node may provide RAN paging area information (e.g., during RAN paging). The serving NG-RAN node may provide RAN paging attempt information. Each paged NG-RAN node may receive the same RAN paging attempt information during a paging attempt. The information may include, for example, one or more of the following: a paging attempt count, the intended number of paging attempts, and/or the next paging area scope. The paging attempt count may be increased (e.g., incremented by one) at a paging attempt (e.g., each paging attempt). The next paging area scope (e.g., if present) may indicate whether the serving NG_RAN node plans to modify the RAN paging area currently selected at the next paging attempt. The paging attempt count may be reset if the WTRU leaves the inactive state (e.g., RRC_INACTIVE state).

WTRU power saving may be implemented for paging monitoring. WTRU power consumption (e.g., caused by false paging alarms) may be reduced by dividing a group of WTRUs monitoring the same PO into multiple subgroups. With subgrouping, a WTRU may monitor PDCCH in a PO for paging, for example, if the subgroup to which the WTRU belongs is paged (e.g., as indicated via an associated PEI). A WTRU may monitor the paging in the WTRU's PO (e.g., if the WTRU does not find its subgroup ID with the PEI configurations in a cell and/or if the WTRU is unable to monitor the associated PEI occasion corresponding to its PO).

Subgroups may have one or more of the following characteristics. Subgroups may be formed based on CN controlled subgrouping. Subgroups may be based on WTRU IDs. A WTRU ID-based subgrouping may be used (e.g., if supported by the WTRU and network). For example, a WTRU ID-based subgrouping may be used if a CN-controlled subgroup ID is not provided by the AMF. The RRC state (e.g., RRC_IDLE or RRC_INACTIVE state) may not impact the subgroup to which the WTRU belongs. Subgrouping support for a cell may be broadcast in system information. For example, the subgrouping support may indicate one or more of the following: CN-controlled subgrouping supported, and/or WTRU ID-based subgrouping supported. The number of subgroups (e.g., total number of subgroups) allowed in a cell may be limited (e.g., up to 8). The total may represent the sum of CN-controlled and WTRU ID-based subgrouping configured by the network. A WTRU configured with a CN-controlled subgroup ID may apply a CN-controlled subgroup ID (e.g., if the cell supports CN-controlled subgrouping). The WTRU may derive a WTRU ID-based subgroup ID (e.g., if the cell supports WTRU ID based subgrouping).

A PEI associated with subgroups may have one or more of the following characteristics. A PEI may support a WTRU ID-based subgrouping, for example, if the PEI is supported by the WTRU. PEI monitoring may be limited (e.g., via system information) to the cell in which the last connection was released, unless the network indicates that the WTRU may not update its last used cell information. A PEI-capable WTRU may store its last used cell information. One or more gNBs supporting the PEI monitoring to the last used cell function may provide the WTRU's last used cell information to the AMF (e.g., in the NG-AP WTRU context release complete message for PEI capable WTRUs). A WTRU that expects an MBS group notification may ignore the PEI and may monitor paging in its PO.

CN-controlled subgrouping may be implemented. For CN-controlled subgrouping, an AMF may be responsible for assigning a subgroup ID to a WTRU. The total number of subgroups for CN-controlled subgrouping may be configured (e.g., by operations and management (OAM). One or more (e.g., up to 8) subgroups may be used for CN-controlled subgrouping. CN-controlled subgrouping support may be homogeneous within an RNA.

FIG. 13 illustrates an example of a procedure for CN-controlled subgrouping. As shown in FIG. 13, at 1301, the WTRU may indicate that the WTRU supports CN-controlled subgrouping (e.g., via NAS signaling). At 1302, the AMF may determine the subgroup ID assignment for the WTRU (e.g., if the WTRU supports CN-controlled subgrouping). At 1303, the AMF may send a subgroup ID to the WTRU (e.g., via NAS signaling). At 1304, the AMF may inform the gNB about the CN assigned subgroup ID for paging the WTRU in an idle state and/or an inactive state (e.g., RRC_IDLE and/or RRC_INACTIVE state). At 1305, the gNB may determine the PO and the associated PEI occasion for the WTRU (e.g., if the paging message for the WTRU is received from the CN and/or generated by the gNB. At 1306, the gNB may (e.g., before the WTRU is paged in the PO) transmit the associated PEI and/or may indicate the corresponding CN-controlled subgroup of the WTRU that may be paged in the PEI.

WTRU ID-based subgrouping may be implemented. The gNB and/or WTRU may determine the subgroup ID for WTRU ID-based subgrouping based on the WTRU ID and/or the total number of subgroups for WTRU ID-based subgrouping in the cell. The total number of subgroups for WTRU ID-based subgrouping may be determined by the gNB for a cell (e.g., each cell). The number of subgroups (e.g., total number of subgroups) for WTRU ID-based subgrouping may be different in different cells.

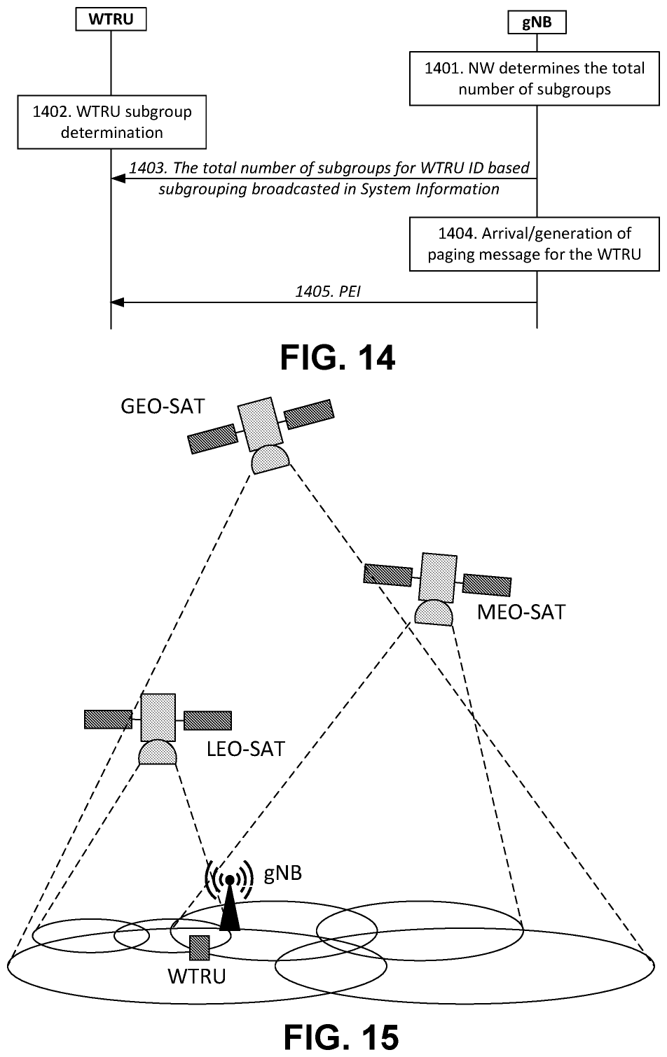

FIG. 14 illustrates an example of a procedure for WTRU ID-based subgrouping. As shown in FIG. 14, at 1401, the gNB may determine the total number of subgroups for a WTRU ID-based subgrouping in a cell. At 1402, the WTRU may determine the WTRU subgroup. At 1403, the gNB may broadcast the total number of subgroups for WTRU ID-based subgrouping in a cell. At 1404, the gNB may determine the PO and/or the associated PEI occasion for the WTRU (e.g., if a paging message for the PEI capable WTRU is received from the CN at the gNB and/or is generated by the gNB). At 1405, the gNB may (e.g., before the WTRU is paged in the PO) transmit the associated PEI and/or may indicate the corresponding subgroup derived based on the WTRU ID of the WTRU that is to be paged in the PEI.

Extended DRX may be implemented for idle and/or inactive states (e.g., RRC_IDLE and RRC_INACTIVE states). One or more of the following may apply if extended DRX (eDRX) is used for idle or inactive states (e.g., RRC_IDLE and RRC_INACTIVE states). In an inactive state (e.g., RRC_INACTIVE), an eDRX configuration for RAN paging may be decided and configured by NG-RAN. In the inactive state (e.g., RRC_INACTIVE), the WTRU may monitor RAN and CN paging. For an idle state (e.g., RRC_IDLE), an eDRX for CN paging may be configured by upper layers. A WTRU in the idle state (e.g., RRC_IDLE state) may monitor CN paging. Information about whether eDRX is allowed on the cell for WTRUs in the idle and inactive states (e.g., RRC_IDLE and RRC_INACTIVE) may be provided (e.g., in system information) separately for the idle and inactive states (e.g., RRC_IDLE and RRC_INACTIVE). The maximum value of an eDRX cycle may be limited (e.g., 10485.76 seconds or 2.91 hours for RRC_IDLE state and 10.24 seconds for RRC_INACTIVE state). A minimum value of an eDRX cycle may be limited (e.g., 2.56 seconds for RRC_IDLE and RRC_INACTIVE states). The hyper SFN (H-SFN) may be broadcast by the cell. The SFN may be incremented by one when the SFN wraps around. Paging Hyperframe (PH) may refer to the H-SFN in which the WTRU starts monitoring paging DRX during a Paging Time Window (PTW) used in RRC_IDLE state. The PH and PTW may be determined based on a formula provided by the AMF, WTRU, and/or NG-RAN. H-SFN, PH and PTW may be used, for example, if the eDRX cycle is greater than the maximum eDRX cycle in the RRC-INACTIVE state (e.g., 10.24 seconds). The WTRU may verify that stored system information remains valid before establishing an RRC connection (e.g., if the eDRX cycle is longer than the system information modification period).

Measurements, mobility, and/or service continuity may be specified for NTN-TN and NTN-NTN. For NTN-NTN mobility, cell reselection may be specified for NTN-NTN Earth-moving cells. Cell reselection may be timing-based and/or location-based cell reselection. NTN-NTN handovers for RRC_CONNECTED WTRUs in a quasi-Earth-fixed cell and Earth-moving cell may be configured to reduce signaling overhead. Cell reselection for RRC_IDLE/INACTIVE WTRUs may be configured to reduce WTRU power consumption (e.g., NTN-TN mobility may be prioritized). Xn/NG signaling may support feeder link switch-over and CHO (e.g., with an exchange of information between gNBs).

A network may include several layers, such as a terrestrial network, LEO, MEO, and/or GEO satellites. Each layer may operate with different cell sizes and/or with different over-the-air propagation delays. A GEO layer may have the largest cell coverage, with the longest propagation delay. A MEO layer and LEO layer may have smaller cell coverage and shorter propagation delay. A terrestrial network may have the smallest cell coverage, with the shortest propagation delay.

FIG. 15 illustrates an example of NTN-TN network layers.

Although examples refer to TN vs. NTN coverage, the examples may be applied to any combination of network layers, such as LEO vs. GEO, TN vs. MEO vs. GEO, and so on.

From a WTRU power saving point of view, a WTRU may consume less power on an NTN (e.g., if TN and NTN coverage exists). An NTN may have wider coverage than a TN. A WTRU camping on an NTN may reduce/minimize neighbor cell measurements, cell reselection, SI reading, etc., particularly for a moving WTRU.

From a NW paging load point of view, paging may use fewer resources for a WTRU camped on an NTN cell. An NTN may provide wider coverage than a TN. A WTRU cell location may be known with one cell or a few cells. There may be no need to escalate paging across multiple cells (e.g., as with paging in TN networks, where the paging may be sent to a subset of cells within a tracking/RAN area first, then another subset, and so on, until the WTRU is reached). A WTRU in a TN may perform cell reselection in an idle state (e.g., RRC_IDLE) within the tracking area, and in an inactive state (e.g., RRC_INACTIVE) within the RAN notification area (e.g., without notifying the network). A network may page in multiple cells to find the WTRU location. A WTRU in NTN (e.g., in GEO) may be less likely to perform several cell reselections (e.g., because the cell areas are large). In other NTN layers (e.g., LEO, Earth moving layers), the cell location may be known. For example, in case of cell reselection within the TA/RNA, a numbers of cells may be within a large geographical area. A WTRU may be paged on one or more cells.

From a latency point of view, there may be lower latency for a WTRU camped on a TN cell. RRC establishment/resume procedures and/or data transfer may be subject to long propagation delays in an NTN. A TN may have lower signaling delay and/or higher data throughput. Notification and delivery of a paging message in an NTN may have a longer latency than in a TN. An NTN may have fewer instances of paging escalation.

Overlapping network layers (e.g., overlapping TN-NTN coverage) may be used to achieve power saving and paging load benefits of NTN without the drawback of longer latency, longer session establishment times, and limited throughput.

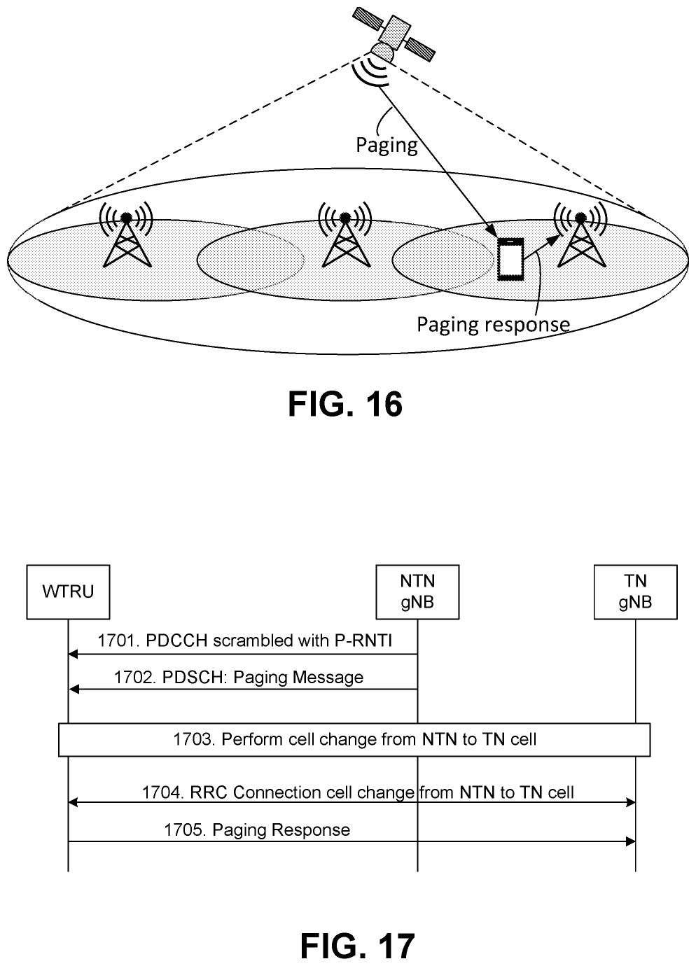

A WTRU in an idle state or inactive state (e.g., RRC_IDLE or RRC_INACTIVE states) may be paged using an NTN cell. The WTRU may respond using a TN cell. An example of NTN paging with a TN response is illustrated in FIG. 16.

FIG. 16 illustrates an example of paging a WTRU in an NTN with a paging response by the WTRU in a TN.

A WTRU may prioritize camping on an NTN. A network may (e.g., based on cell reselection principles) provide (e.g., absolute) priority of an NTN frequency layer over TN frequency layers. An idle mode WTRU may camp on NTN (e.g., if the WTRU reselects to the highest priority layer that is available, and if the WTRU meets the cell reselection criteria). A WTRU may use one or more techniques to prioritize or camp on an NTN.

A mobile terminated call may be initiated on the TN (e.g., if the WTRU is camped on an NTN). Allowing the WTRU to camp on NTN may reduce the paging load in the NW. For example, because the NTN cell is large, paging escalation (e.g., page on the last known cell, then page on multiple other cells in the area) and/or paging by default in multiple cells may be reduced/minimized compared to paging on a TN. There may be a power saving benefit for the WTRU camped on an NTN. For example, because there may be less need to perform neighbor cell measurements, cell reselections, etc. (e.g., due to the relatively large geographical size of NTN cells), particularly if the WTRU is moving.

While camping on an NTN may provide power saving benefits to the WTRU and paging load benefits to the network, latency may be increased due to longer signal propagation times. In some examples, RRC connection establishment and/or call establishment may be performed on NTN followed by performing a handover from the NTN to a TN. A message (e.g., each message) involved in the setup procedure may be subject to a long delay, which may make call establishment time significantly longer on NTN compared to call establishment on TN. In some examples, a redirection (e.g., an option for moving from NR to LTE) may be performed. A redirection may incur relatively long latency due to the exchange of several RRC messages before the change of RAT occurs. Latency may be improved, for example, if the change of RAT (e.g., NTN to TN) occurs at the earliest possible time. A WTRU may perform a cell reselection or a redirection to TN in response to receiving paging. A WTRU response to paging in the TN may reduce the latency for call establishment, for example, because the WTRU and network may incur/experience a shorter propagation delay starting from Msg1 (e.g., random access). The call setup may be performed on TN (e.g., with only paging message delivery taking longer on the NTN). The likelihood of paging escalation among multiple cells may be reduced (e.g., because in many cases the WTRU location is known to the network at a cell level).

FIG. 17 illustrates an example procedure for paging a WTRU in an NTN cell with a response by the WTRU in a TN cell.

As shown in FIG. 17, at 1701 the WTRU may be camped on an NTN. The WTRU may receive an indication that a paging message is scheduled. For example, the WTRU may receive a PDCCH scrambled with P-RNTI (e.g., or another P-RNTI for this type of paging). The PDCCH may indicate that a paging message is scheduled. At 1702, the WTRU may receive a paging message (e.g., on PDSCH) from the NTN. The paging message may indicate for the WTRU to respond to the paging message on a TN. At 1703, the WTRU may perform a cell change from NTN to TN (e.g., to camp on a TN cell). At 1704, the WTRU may send, to a TN node associated with the TN cell, an access request to initiate or resume a connection (e.g., an RRC connection), for example, on the TN cell. For example, the WTRU may send the access request to initiate or resume a connection on the TN cell using the cause “mt-access” (or other establishment cause for this type of MT access). At 1705, the WTRU may send an NAS paging response message (e.g., to the TN).

The paging message may indicate a cell change (e.g., from an NTN cell to a TN cell). A paging message may include a paging record. The paging record may include a list of WTRU identities (e.g., to address a specific WTRU). In some examples, the paging record list may (e.g., be extended to) include an indication (e.g., a 1-bit indication) associated with the WTRU ID included in the paging record. The WTRU may be configured to respond to the indication. For example, the WTRU may (e.g., based on receiving the indication) respond by triggering a change of cell from the NTN to the TN (e.g., to send a paging response to the paging message).

The paging message may include an indication of one or more preferred target TN cells (e.g., a preferred carrier frequency or ARFCN) and/or individual TN cell identities. For example, the paging message may indicate a first target TN cell and a second target TN cell. The paging message may indicate first priority information associated with the first target TN cell, and second priority information associated with the second target TN cell.

Each target TN cell may be associated with a reference signal quality (e.g., a first target TN cell is associated with a first reference signal quality, and a second target TN cell is associated with a second reference signal quality). For example, a preferred carrier frequency indication may include a threshold RSRP and/or RSRQ value (e.g., above which the cell on the carrier may be considered suitable to complete the paging response). The WTRU may select a TN cell based on the reference signal qualities of the target TN cells (e.g., if a signal quality satisfies a threshold value/condition). The WTRU may (e.g., if multiple TN cells have signal levels above the threshold(s)) choose a TN cell according to an additional condition (e.g., satisfy a best TN cell condition) or choose a TN cell at random.

The WTRU may be configured (e.g., via signaling) prior to the reception of the paging indication to respond on the other network type. The WTRU may be configured with the preferred target TN cells (e.g., frequency, PCI, etc.) and/or one or more signal level thresholds for determining whether to respond on the TN cell. A configuration may be provided in the RRC release message that sent the WTRU to the IDLE/INACTIVE state, in an RRC reconfiguration message or broadcasted signaling while the WTRU is in CONNECTED state, in a broadcast signaling while the WTRU is in IDLE/INACTIVE state, via a higher layer or non-RAN level configuration (e.g., such as OAM), and/or the like.

The paging message may include first timing information associated with the first target TN cell, and second timing information associated with the second target TN cell. For example, the paging message may include a timing relationship between the NTN cell and the TN cell (e.g., to reduce synchronization time, and/or to assist in determining the target SSB location). The WTRU may apply timing information associated with the selected TN cell. For example, the WTRU may apply the first timing information if the WTRU selects the first target TN cell. The WTRU may apply the second timing information if the WTRU selects the second target TN cell.

The paging message may include a service type indication. Service types may be associated with a network type. For example, for some services, a WTRU may respond on the same cell, and for other services, the WTRU may move to another network or RAT type to respond.

The paging message may include a cell reselection priority indication (e.g., indicating priority information associated with available TN cells). For example, a cell reselection priority indication may indicate a priority for the serving (NTN) frequency (e.g., an indication to consider the frequency as lower priority than the configured TN frequencies) and/or a priority for the target (TN) one or more frequencies (e.g., and indication to consider the target frequency as higher priority than the NTN frequencies). A cell reselection priority indication may include respective priority value(s) (e.g., an explicit priority value(s)) for the serving and/or target frequencies. The WTRU may perform cell reselection evaluation using the assigned or determined priority value(s). For example, the WTRU may select a TN cell, from the first target TN cell and the second target TN cell, based at least on first priority information associated with the first target TN cell and second priority information associated with the second target TN cell.

The paging message may include an indication of uplink resources to use on the target cell when initiating a paging response. For example, the uplink resource may be a specific PRACH preamble or RACH occasion.

A WTRU may determine a target frequency and/or one or more target frequency priorities based on one or more potential target frequencies (e.g., based on the WTRU ID). The WTRU may perform a cell reselection to the determined frequency (e.g., based on the determined target frequency priorities). For example, each target TN cell may be associated with a frequency (e.g., a first target TN cell is associated with a first frequency, and a second target TN cell is associated with a second frequency). The WTRU may select a TN cell based on the associated frequency. For example, the WTRU may select the first target TN cell if the first frequency is closer than the second frequency to the target frequency (e.g., if the difference between the first frequency and the target frequency is less than the difference between the second frequency and the target frequency). The WTRU may select the second target TN cell if the second frequency is closer than the first frequency to the target frequency (e.g., if the difference between the first frequency and the target frequency is greater than the difference between the second frequency and the target frequency).

The paging message may include an index to a configuration. The configuration may be pre-configured, for example, in broadcast system information and/or in a table defined/configured in a specification. The broadcast information corresponding to the index may include information that the WTRU may apply when performing the change of network type. The paging message may indicate one of several pre-configured network change configurations.

The WTRU may store the system information blocks of TN cell(s) (e.g., known TN cell(s). The WTRU may use the system information blocks upon receiving a paging message indicating for the WTRU to respond on the TN. The WTRU may verify (e.g., by reading the SIB1 of a known cell) that the stored system information is valid (e.g., while the WTRU is reselecting the TN cells). The stored system information may be associated with a validity time. The WTRU may consider the stored system information as valid if the timer is still running. The WTRU may not need to read the TN cell's system information (e.g., including SIB1) except MIB (e.g., because MIB includes SFN information and forms part of the SSB). This may reduce the time needed to perform the cell change and send a paging response on the TN cell.

The WTRU may be configured to monitor for an RNTI (e.g., a redirection RNTI). A redirection type of RNTI may be similar to a P-RNTI (e.g., in the sense that WTRUs may monitor for the P-RNTI and receive a paging message). A difference between a redirection RNTI and a P-RNTI may be that paging notifications scrambled with the redirection RNTI may be decoded by (e.g., only by) WTRUs that have been configured to use the redirection RNTI. A WTRU may be configured during a previous connection, and/or based on hard-coding in the WTRU (e.g., by the manufacturer or the network operator).

The WTRU may select a TN cell based on satisfaction of a condition. For example, the condition may be satisfied if the paging message is scrambled with a RNTI associated with cell redirection (e.g., a redirection RNTI). Reception of a paging indication scrambled with the redirection RNTI may (e.g., implicitly) indicate that the WTRU should respond on a different network type (e.g., as described herein, if the WTRU receives the paging message from an NTN, the WTRU may respond on a TN).

WTRUs may be allocated a CN-controlled subgroup to operate using PEI. The network may configure a WTRU to respond to a paging indication and paging message. The WTRU's response to the paging message or paging indication may be triggered by a PEI addressed to a subgroup (e.g., on another network type).

Paging may include an indication to perform (e.g., only perform) redirection (e.g., in anticipation of a service start). An indication may be used to update priorities, or to reselect to a specific frequency. An indication may not cause a paging response to be initiated on the target frequency. The indication may (e.g., be configured to) cause the WTRU to perform a cell reselection and monitor for paging on the target frequency. An indication may be associated with a validity timer. The WTRU may reset updated priorities or cell reselection information that was determined based on the paging notification in the NTN RAT. The WTRU may return to camping on NTN if the WTRU has not received a paging message on the target frequency by expiration of the timer.

The paging may indicate to the WTRU to send a measurement report, for example to send a measurement report to the NTN (e.g., an NTN cell). The measurement report may indicate a request for the first priority information associated with the first target TN cell and the second priority information associated with the second target TN cell. The priority information may be based on the measurement report. The measurement report may include a request for the best n TN cell(s) (e.g., so that the network may perform a redirection to a specific carrier or cell based on the reported measurements).

The indication to perform reselection/redirection/prioritization of a TN cell or carrier from an NTN carrier based on paging may be associated with a timer. The WTRU may send an access request to the TN cell. The WTRU may start the timer upon sending the access request. The WTRU may fail to determine a suitable cell on the target carriers or cells, fail to successfully establish an RRC connection, and/or fail to receive a random-access response by expiration of the timer (e.g., before the timer expires). The WTRU may (e.g., on a condition that the connection failed or no access response was received by expiration of the timer) send a response to the NTN (e.g., on the NTN cell) and/or continue to monitor for subsequent paging from the NTN (e.g., on the NTN cell). Other failure conditions may be used, such as an RRC connection reject on the target cell, a RACH failure (e.g., WTRU performs the maximum allow RACH retransmissions), a failure to read system information on the target cell, a backoff indicator in a random access response. A failure may cause the WTRU to return to the original cell and/or send a paging response on the original cell.

A WTRU may provide a paging response (e.g., after performing the cell change in response to receiving a paging message). The WTRU may attempt to perform an RRC connection establishment or an RRC connection resume (e.g., to transmit a paging response message). A paging response message may include a service request, an extended service request, another NAS message, an RRC connection establishment request, and/or a resume message.

The paging response message may indicate that the paging response (e.g., access request) was triggered by an NTN node. For example, the paging response message may include an indication that the paging response is provided in response to a paging message received on another (e.g., NTN) cell. A paging response may include an identifier of the other (e.g., NTN) cell. For example, the identifier of the other (e.g., NTN) cell may be a physical cell identity, a tracking area code, and/or a RAN notification area code. A paging response message may include measurement results of other cells that the WTRU has detected and/or measured (e.g., such as a list of the best n cells). The WTRU may include timing information associated with TN cells in the paging response. For example, the timing information may include the time since receiving the paging indication or the paging message on the other network. The paging response message may include a service type indicator (e.g., an indication of the service type indicated in the paging message). The WTRU may select a TN cell based on the service type indicator. The paging response message may include the paging record, and/or an identifier included in the paging record that was included in the paging message.

An RRC connection establishment or resume message may include a cause value (e.g., “mt-access-ntn”). The cause value may indicate that the connection is being established in response to paging on the other network (e.g., NTN).

The TN cell may provide a set of uplink resources (e.g., RACH resources or a set of PRACH preambles) for the WTRU to select from when initiating access to a TN cell in response to paging on the other network (e.g., NTN). For example, the TN cell may provide the resources (e.g., directly) to the WTRU (e.g., before the WTRU selects the NTN). The TN cell may provide the resources to the NTN cell. The NTN cell may forward the resources to the WTRU.

Each TN cell may be associated with a different set of uplink resources. The WTRU may use the uplink resources associated with the selected TN cell to send the access request. Transmission of a PRACH preamble using a reserved resource or preamble may (e.g., implicitly) indicate that the WTRU is responding to paging on another network (e.g., NTN), and/or may separate access for WTRUs already camped on the TN cell from WTRUs responding in response to paging on the other network (e.g., NTN).

Although examples describe paging a WTRU on an NTN and the WTRU responding on a TN, the examples are equally applicable to scenarios where the network pages the WTRU on a TN and the WTRU responds on an NTN.

Although examples describe TN and NTN, the examples are equally applicable to scenarios involving other networks or network layers. For example: a WTRU paged on a GEO layer may (e.g., be informed to) respond on a LEO layer; a WTRU paged on a GEO layer may (e.g., be informed to) respond on a MEO layer; a WTRU paged on a MEO layer, and informed to respond on a TN; and so on.

A WTRU may be configured to be paged on a first layer (e.g., GEO layer) and may respond on one or more other layers (e.g., depending on priority and availability of cells at the layer). For example, a WTRU may (e.g., be configured to) be paged on a GEO layer and respond on TN (e.g., if a suitable cell at the TN level is available), a LEO layer/cell (e.g., if a suitable cell at the LEO level may available), a MEO layer/cell (e.g., if a suitable cell at the MEO level may available), and/or a GEO layer/cell (e.g., where the WTRU was paged).

A WTRU may be configured to monitor paging at multiple layers. Each paging may be associated with a different configuration, such as DRX cycles, paging occasions, etc. For example, a WTRU may be paged in both an NTN and a TN, with indications in the paging to respond in the TN.

Systems, methods, and instrumentalities are described herein for paging and responding in different networks, such as a non-terrestrial network (NTN) to a terrestrial network (TN), a TN to an NTN, an NTN to another NTN, etc. For example, a wireless transmit/receive unit (WTRU) (e.g., camping in an idle or inactive state) may (e.g., be configured to) monitor for paging on a first network (e.g., the NTN). The WTRU may receive a paging message on the NTN. The paging message may provide an indication to respond on a second network (e.g., the TN). The WTRU may perform a cell reselection to the TN. The WTRU may respond to the paging on the first network (e.g., the NTN) by sending a paging response message on the second network (e.g., the TN).

An example WTRU may receive, from an NTN node, a paging message. The paging message may indicate: for the WTRU to respond to the paging message on a TN, a first target TN cell, a second target TN cell, first priority information associated with the first target TN cell, second priority information associated with the second target TN cell, first timing information associated with the first target TN cell, and second timing information associated with the second target TN cell. The WTRU may select a TN cell, from the first target TN cell and the second target TN cell, based at least on the first priority information and the second priority information. The WTRU may apply timing information associated with the selected TN cell. The WTRU may send, to a TN node associated with the selected TN cell, an access request to initiate a connection on the selected TN cell. The access request may indicate that the access request was triggered by the NTN node.

Selecting the TN cell, from the first target TN cell and the second target TN cell, may be further based on satisfaction of a condition. The condition may be satisfied if the paging message is scrambled with a radio network temporary identifier (RNTI) associated with cell redirection. The paging message may include a service type indicator. Selecting the TN cell, from the first target TN cell and the second target TN cell, may be further based on the service type indicator.

The paging message may further indicate first uplink resources associated with the first target TN cell and second uplink resources associated with the second target TN cell. Sending the access request to the selected TN cell may involve sending the access request using uplink resources associated with the selected TN cell.

The first target TN cell may be associated with a first reference signal quality. The second target TN cell may be associated with a second reference signal quality. Selecting the TN cell, from the first target TN cell and the second target TN cell, may be further based on the first reference signal quality and the second reference signal quality.

The first target TN cell may be associated with a first frequency. The second target TN cell may be associated with a second frequency. Selecting the TN cell, from the first target TN cell and the second target TN cell, may be further based on a first difference between the first frequency and a target frequency, and a second difference between the second frequency and the target frequency.

The WTRU may send a measurement report to the NTN node. The measurement report may indicate a request for the first priority information associated with the first target TN cell and the second priority information associated with the second target TN cell. The first priority information and the second priority information may be based on the measurement report.

The WTRU may, upon sending the access request, start a timer. On a condition that the connection failed or no access response was received by expiration of the timer, the WTRU may send a response to the NTN node, or monitor for subsequent paging messages from the NTN node.

An example WTRU may identify one or more target TN cells. The WTRU may receive, from an NTN node, a paging message that indicates: a TN cell of the one or more target TN cells, for the WTRU to respond to the paging message on the TN cell, and timing information associated with the TN cell. The WTRU may apply the timing information associated with the TN cell. The WTRU may send, to a TN node associated with the TN cell, an access request to initiate a connection on the TN cell. The access request may indicate that the access request was triggered by the NTN node.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1. A wireless transmit/receive unit (WTRU), the WTRU comprising:
a processor, wherein the processor is configured to:
receive, from a non-terrestrial network (NTN) node, a paging message that indicates: for the WTRU to respond to the paging message on a terrestrial network (TN), a first target TN cell, a second target TN cell, first priority information associated with the first target TN cell, second priority information associated with the second target TN cell, first timing information associated with the first target TN cell, and second timing information associated with the second target TN cell;
select a TN cell, from the first target TN cell and the second target TN cell, based at least on the first priority information and the second priority information;
apply timing information associated with the selected TN cell; and
send, to a TN node associated with the selected TN cell, an access request to initiate a connection on the selected TN cell, wherein the access request indicates that the access request was triggered by the NTN node.

2. The WTRU of claim 1, wherein the processor being configured to select the TN cell, from the first target TN cell and the second target TN cell, is further based on satisfaction of a condition, and wherein the condition is satisfied if the paging message is scrambled with a radio network temporary identifier (RNTI) associated with cell redirection.

3. The WTRU of claim 1, wherein the paging message further comprises a service type indicator, and wherein the processor being to configured select the TN cell, from the first target TN cell and the second target TN cell, is further based on the service type indicator.

4. The WTRU of claim 1, wherein the paging message further indicates first uplink resources associated with the first target TN cell and second uplink resources associated with the second target TN cell, and wherein the processor being configured to send the access request to the selected TN cell comprises the processor being configured to send the access request using uplink resources associated with the selected TN cell.

5. The WTRU of claim 1, wherein the first target TN cell is associated with a first frequency, wherein the second target TN cell is associated with a second frequency, and wherein the processor being to configured select the TN cell, from the first target TN cell and the second target TN cell, is further based on a first difference between the first frequency and a target frequency, and a second difference between the second frequency and the target frequency.

6. The WTRU of claim 1, wherein the processor is further configured to send a measurement report to the NTN node, wherein the measurement report indicates a request for the first priority information associated with the first target TN cell and the second priority information associated with the second target TN cell, and wherein the first priority information and the second priority information are based on the measurement report.

7-14. (canceled)

15. The WTRU of claim 1, wherein the processor is further configured to:
receive an access response from the TN node, wherein the access response indicates that the TN node accepts the access request to initiate the connection on the selected TN cell; and
establish a connection on the selected TN cell.

16. The WTRU of claim 1, wherein the processor is further configured to:
establish a connection on the selected TN cell; and
send, to the TN node, a response to the paging message.

17. A method, performed by a wireless transmit/receive unit (WTRU), the method comprising:
receiving, from a non-terrestrial network (NTN) node, a paging message that indicates: for the WTRU to respond to the paging message on a terrestrial network (TN), a first target TN cell, a second target TN cell, first priority information associated with the first target TN cell, second priority information associated with the second target TN cell, first timing information associated with the first target TN cell, and second timing information associated with the second target TN cell;
selecting a TN cell, from the first target TN cell and the second target TN cell, based at least on the first priority information and the second priority information;
applying timing information associated with the selected TN cell; and
sending, to a TN node associated with the selected TN cell, an access request to initiate a connection on the selected TN cell, wherein the access request indicates that the access request was triggered by the NTN node.

18. The method of claim 17, wherein selecting the TN cell, from the first target TN cell and the second target TN cell, is further based on satisfaction of a condition, and wherein the condition is satisfied if the paging message is scrambled with a radio network temporary identifier (RNTI) associated with cell redirection.

19. The method of claim 17, wherein the paging message further comprises a service type indicator, and wherein selecting the TN cell, from the first target TN cell and the second target TN cell, is further based on the service type indicator.

20. The method of claim 17, wherein the paging message further indicates first uplink resources associated with the first target TN cell and second uplink resources associated with the second target TN cell, and wherein sending the access request to the selected TN cell comprises sending the access request using uplink resources associated with the selected TN cell.

21. The method of claim 17, wherein the first target TN cell is associated with a first frequency, wherein the second target TN cell is associated with a second frequency, and wherein selecting the TN cell, from the first target TN cell and the second target TN cell, is further based on a first difference between the first frequency and a target frequency, and a second difference between the second frequency and the target frequency.

22. The method of claim 17, wherein the method further comprises sending a measurement report to the NTN node, wherein the measurement report indicates a request for the first priority information associated with the first target TN cell and the second priority information associated with the second target TN cell, and wherein the first priority information and the second priority information are based on the measurement report.

23. The method of claim 17, wherein the method further comprises:
receiving an access response from the TN node, wherein the access response indicates that the TN node accepts the access request to initiate the connection on the selected TN cell; and
establishing a connection on the selected TN cell.

24. The method of claim 17, wherein the method further comprises:
establishing a connection on the selected TN cell; and
sending, to the TN node, a response to the paging message.

25. A wireless transmit/receive unit (WTRU), the WTRU comprising:
a processor, wherein the processor is configured to:
identify one or more target terrestrial network (TN) cells;
receive, from a non-terrestrial network (NTN) node, a paging message that indicates: a TN cell of the one or more target TN cells, for the WTRU to respond to the paging message on the TN cell, and timing information associated with the TN cell;
apply the timing information associated with the TN cell; and
send, to a TN node associated with the TN cell, an access request to initiate a connection on the TN cell, wherein the access request indicates that the access request was triggered by the NTN node.

26. The WTRU of claim 25, wherein the processor is further configured to:
upon sending the access request, start a timer; and
on a condition that the connection failed or no access response was received by expiration of the timer:
send a response to the NTN node, or
monitor for subsequent paging messages from the NTN node.

27. The WTRU of claim 25, wherein the processor is further configured to:
receive an access response from the TN node, wherein the access response indicates that the TN node accepts the access request to initiate the connection on the TN cell; and
establish a connection on the TN cell.

28. The WTRU of claim 25, wherein the processor is further configured to:
establish a connection on the TN cell; and
send, to the TN node, a response to the paging message.
